(19) United States
(12) Patent Application Publication
(10) Pub. No.: US 2023/0367335 A1
(43) Pub. Date: Nov. 16, 2023

(54) AUTONOMOUS MOBILE APPARATUS, FLYING SYSTEM, CONTROL METHOD, AND PROGRAM

(71) Applicant: SONY GROUP CORPORATION, TOKYO (JP)

(72) Inventors: HIROTAKA TANAKA, TOKYO (JP); KATSUNORI HONMA, TOKYO (JP); MASASHI ASAMI, TOKYO (JP); SATOSHI SUZUKI, TOKYO (JP)

(21) Appl. No.: 18/246,561

(22) PCT Filed: Sep. 30, 2021
(86) PCT No.: PCT/JP2021/036076

§ 371 Date: Mar. 24, 2023

(30) Foreign Application Priority Data
Oct. 7, 2020 (JP) 2020-169973

(51) Int. Cl. G05D 1/10; B64U 10/60; B64F 1/02

(52) U.S. Cl. CPC G05D 1/101; B64U 10/60; B64F 1/027

(57) ABSTRACT

To provide a technology capable of realizing safety flight of a flying object without limiting a flight area for the flying object. An autonomous mobile apparatus according to the present technology includes a mobile unit, a bumper unit, and a control unit. The mobile unit moves an autonomous mobile apparatus by driving. The bumper unit capable of reducing a fall impact of a flying object. The control unit controls driving of the mobile unit on the basis of a position of the flying object.

### TECHNICAL FIELD

The present technology relates to a technology for safety flight in a flying object such as a drone.

### BACKGROUND ART

In management and operation for drones, fall accidents are heavy risks. Damages of airframes of drones, cargoes transported by the drones, and the like due to fall impacts of the drones cause a great economic and time loss.

Therefore, many safety apparatuses, protection functions, and the like are mounted on drones in recent years. However, if they encounter unexpected troubles such as sudden winds and errors, they may fall down because their safety apparatuses, protection functions, and the like cannot address these troubles in time.

Patent Literature 1 below has disclosed a technology of suspending a drone from a wire-like guide in order to prevent a fall of the drone.

### CITATION LIST

### Patent Literature

Patent Literature 1: Japanese Patent Application Laid-open No. 2017-214037

### DISCLOSURE OF INVENTION

### Technical Problem

A system of suspending a drone from a wire-like guide has a problem in that it limits the drone's flight area to the guide's installation area.

In view of the above-mentioned circumstances, it is an objective of the present technology to provide a technology capable of realizing safety flight of a flying object without limiting a flight area for the flying object.

### Solution to Problem

An autonomous mobile apparatus according to the present technology includes a mobile unit, a bumper unit, and a control unit.

The mobile unit moves an autonomous mobile apparatus by driving.

The bumper unit capable of reducing a fall impact of a flying object.

The control unit controls driving of the mobile unit on the basis of a position of the flying object.

This configuration can realize safety flight of the flying object without limiting a flight area for the flying object.

A flying system according to the present technology includes a flying object and an autonomous mobile apparatus.

The autonomous mobile apparatus includes a mobile unit, a bumper unit, and a control unit.

The mobile unit moves the autonomous mobile apparatus by driving.

The bumper unit is capable of reducing a fall impact of the flying object.

The control unit controls driving of the mobile unit on the basis of a position of the flying object.

A control method according to the present technology controls driving of a mobile unit on the basis of a position of a flying object in an autonomous mobile apparatus, the autonomous mobile apparatus including the mobile unit that moves the autonomous mobile apparatus by driving and a bumper unit capable of reducing a fall impact of the flying object.

A program according to the present technology causes an autonomous mobile apparatus to execute processing of controlling driving of a mobile unit on the basis of a position of a flying object, the autonomous mobile apparatus including the mobile unit that moves the autonomous mobile apparatus by driving and a bumper unit capable of reducing a fall impact of the flying object.

### BRIEF DESCRIPTION OF DRAWINGS

FIG. 1 A schematic view showing a flying system according to a first embodiment.

FIG. 2 A schematic perspective view showing an autonomous mobile apparatus in the flying system.

FIG. 3 A block diagram showing internal configurations of a drone.

FIG. 4 A block diagram showing internal configurations of a controller.

FIG. 5 A block diagram showing internal configurations of the autonomous mobile apparatus.

FIG. 6 A flowchart showing processing at a control unit of the autonomous mobile apparatus.

FIG. 7 A diagram showing a state in determining a distance by which the autonomous mobile apparatus should be moved on the basis of a distance between the autonomous mobile apparatus and the drone and a line-of-sight angle of the drone with respect to the autonomous mobile apparatus.

FIG. 8 A flowchart showing processing at a control unit of the drone.

FIG. 9 A flowchart showing processing at a control unit of the controller.

FIG. 10 A diagram showing an example in a case of a cushion-type bumper unit.

FIG. 11 A diagram showing an example in a case of an arm suspension-type bumper unit.

### MODE(S) FOR CARRYING OUT THE INVENTION

Hereinafter, embodiments according to the present technology will be described with reference to the drawings.

### First Embodiment

<Overall Configuration and Configurations of Respective Units>

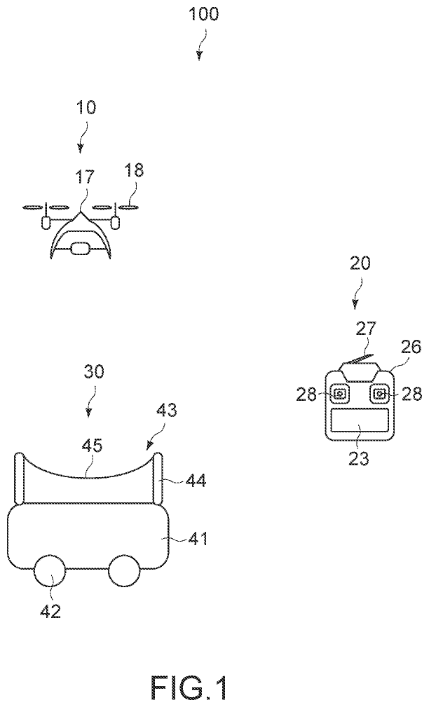

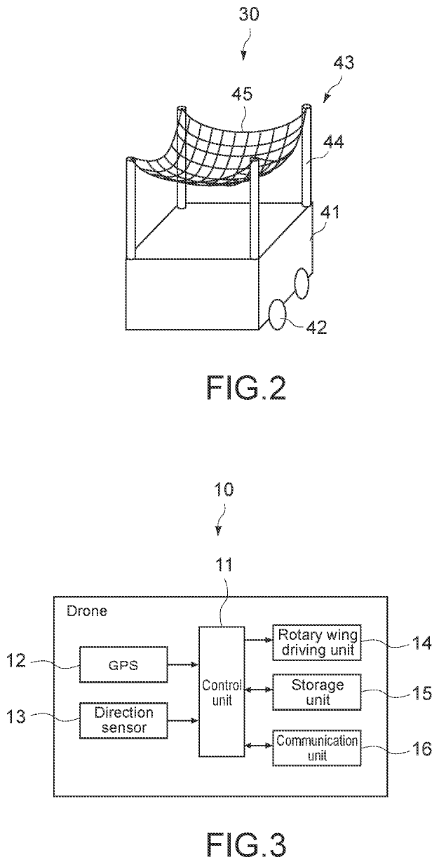

FIG. 1 is a schematic view showing a flying system 100 according to a first embodiment. FIG. 2 is a schematic perspective view showing an autonomous mobile apparatus 30 in the flying system 100.

As shown in FIGS. 1 and 2, the flying system 100 includes a drone 10, a drone controller 20, and an autonomous mobile apparatus 30. The autonomous mobile apparatus 30 can autonomously move tracking the drone 10 and can reduce a fall impact of the drone 10. It should be noted that in the description of the present embodiment, “tracking” means moving the autonomous mobile apparatus 30 to a position (position under the drone 10) capable of reducing a fall impact of the drone 10 while moving the autonomous mobile apparatus 30 along with a movement of the drone 10.

[Drone 10]

The drone 10 has various applications such as aerial shooting, inspection, transportation, security, life saving, biological research, spraying of agrochemicals, and hobby, and may have any other applications.

The drone 10 includes a drone main body 17 and one or more rotary wings 18. The one or more rotary wings 18 are provided in the drone main body 17. The drone 10 can perform various operations such as forward, rearward, leftward, and rightward movements, ascending and descending operations, and rolling operations by controlling driving of the rotary wings 18.

FIG. 3 is a block diagram showing internal configurations of the drone 10. As shown in FIG. 3, the drone 10 includes a control unit 11, a global positioning system (GPS) 12, a direction sensor 13, a rotary wing driving unit 14, a storage unit 15, and a communication unit 16.

The control unit 11 executes various arithmetic operations on the basis of various programs stored in the storage unit 15 and comprehensively controls the respective units of the drone 10.

The control unit 11 realized by hardware or a combination of hardware and software. The hardware is configured as a part of the control unit or the entire control unit. Examples of the hardware can include a central processing unit (CPU), a graphics processing unit (GPU), a vision processing unit (VPU), a digital signal processor (DSP), a field programmable gate array (FPGA), an application specific integrated circuit (ASIC), and a combination of two or more of them. It should be noted that the same applies to a control unit 21 of a controller 20 or a control unit 31 of the autonomous mobile apparatus 30.

The GPS 12 generates GPS position information (a self-position of the drone 10 in a global coordinate system) on the basis of signals from a plurality of GPS satellites and outputs the GPS position information to the control unit 11. The direction sensor 13 is for example a geomagnetic sensor and acquires information about a direction (orientation, attitude) of the drone 10 and outputs the information to the control unit.

Although the GPS 12 and the direction sensor 13 estimate self-position and attitude of the drone 10 in the example here, other means such as simultaneous localization and mapping (SLAM) and light detection and ranging (LIDAR) may estimate the self-position and attitude of the drone 10.

The rotary wing driving unit 14 is for example a motor and drives the rotary wings 18 in accordance with the control of the control unit.

The storage unit 15 has various programs necessary for processing of the control unit 11, a nonvolatile memory for storing various types of data, and a volatile memory used as a working area for the control unit.

It should be noted that such various programs may be read from a portable recording medium such as an optical disc, a semiconductor memory, or the like or may be downloaded from a server apparatus over a network. The same applies to a program of the controller 20 or a program of the autonomous mobile apparatus 30.

The communication unit 16 is capable of communication between the controller 20 and the autonomous mobile apparatus 30.

Here, the drone 10 is an example of a flying object. The flying object is not limited to the drone 10, and may be a radio-controlled aircraft or a helicopter for example. Typically, any apparatus may be employed as long as the flying object can fly and is relatively compact (has such a size that the autonomous mobile apparatus 30 can reduce a fall impact).

[Controller 20]

A user uses the controller 20 for controlling the movement of the drone 10. As shown in FIG. 1, the controller 20 includes a casing 26, an antenna 27, two control sticks 28, and a display unit 23.

The antenna 27 enables signal exchange between the drone 10 and the autonomous mobile apparatus 30.

The two control sticks 28 are respectively assigned with various operations such as forward, rearward, leftward, and rightward movements, ascending and descending operations, and rolling operations of the drone 10.

The display unit 23 displays various images on a screen in accordance with the control of the control unit 21. For example, the display unit 23 displays a map for the user to generate a flight path for the drone 10 as will be described later. A proximity sensor that detects proximity of user fingers and the like may be provided on the screen of the display unit 23.

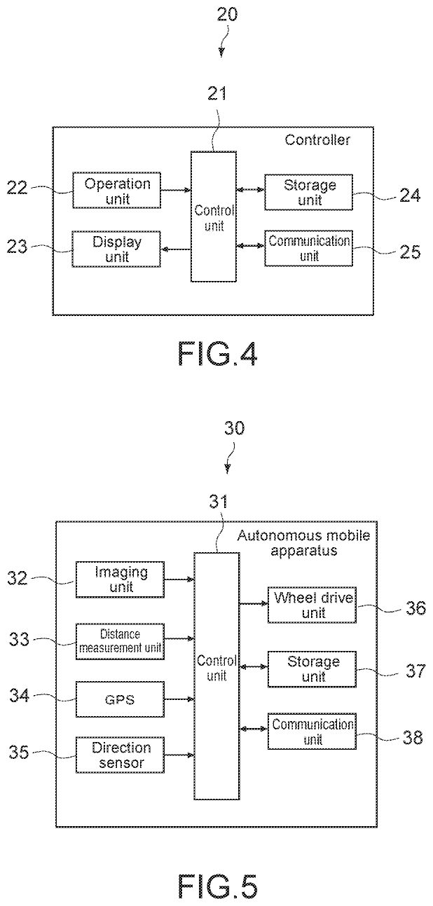

FIG. 4 is a block diagram showing internal configurations of the controller 20. As shown in FIG. 4, the controller 20 includes the control unit 21, an operation unit 22, the display unit 23, a storage unit 24, and a communication unit 25.

The control unit 21 executes various arithmetic operations on the basis of various programs stored in the storage unit 24 and comprehensively controls the respective units of the controller 20.

The operation unit 22 includes the two control sticks 28, the proximity sensor provided on the screen of the display unit 23, and the like. The operation unit 22 detects an operation made by the user and outputs an operation signal according to the operation to the control unit 21.

The storage unit 24 has various programs necessary for the processing of the control unit 21, a nonvolatile memory for storing various types of data, and a volatile memory used as a working area for the control unit 21. The communication unit 25 is capable of communication between the drone 10 and the autonomous mobile apparatus 30 via the antenna 27.

Although the controller 20 is a dedicated controller 20 in the example shown in FIG. 1, a universal apparatus such as a smartphone and a tablet personal computer (PC) may be used as the controller 20. Alternatively for example connecting a smartphone or the like to the dedicated controller 20 including the control sticks 28 may configure the controller 20 integrally.

[Autonomous Mobile Apparatus 30]

As shown in FIGS. 1 and 2, the autonomous mobile apparatus 30 includes an autonomous mobile apparatus body 41, four wheels 42 provided in the autonomous mobile apparatus body 41, and a bumper unit 43 provided in the autonomous mobile apparatus body 41.

The autonomous mobile apparatus body 41 is slightly bigger than the drone 10 in order to receive the drone 10 suitably if the drone 10 falls. Although the autonomous mobile apparatus body 41 has a rectangular parallelepiped shape in the example shown in FIGS. 1 and 2, this shape is not particularly limited.

The wheels (mobile unit) 42 is capable of moving the autonomous mobile apparatus 30 by driving itself. The wheels 42 are capable of moving the autonomous mobile apparatus body 41 forward and rearward by rotating and tilting itself. Moreover, the wheels 42 are capable of rolling the autonomous mobile apparatus body 41 leftward and rightward. Although four wheels 42 are provided in the example shown in the figure, the number of wheels 42 can vary as appropriate.

The autonomous mobile apparatus 30 movable through the wheels 42 is described in the example here. Alternatively, the autonomous mobile apparatus 30 may be movable through a continuous track or legs (self-driving type) or may be movable through wings, rotary wings, or the like (flying type). Typically, the autonomous mobile apparatus 30 may be movable in any form.

The bumper unit 43 is capable of reducing a fall impact of the flying object. The bumper unit 43 includes four poles 44 and a net portion 45. The four poles 44 are mounted upright on the autonomous mobile apparatus body 41. The four poles 44 support the net portion 45.

The four poles 44 have strength and height adjusted so that the net portion 45 can reduce an impact suitably when the net portion 45 receives a falling drone 10.

The net portion 45 has a rectangular shape. The net portion 45 has four corners respectively fixed on top ends of the four poles 44. The four poles 44 fixe the net portion 45 in a slightly bent form in order to protect the falling drone 10 suitably.

It should be noted that the number of poles 44 and the shape of the net portion 45 can vary as appropriate (the number of poles 44: 3, 4, 5, . . . ; the shape of the net portion 45: triangle, rectangle, pentagon, . . . ).

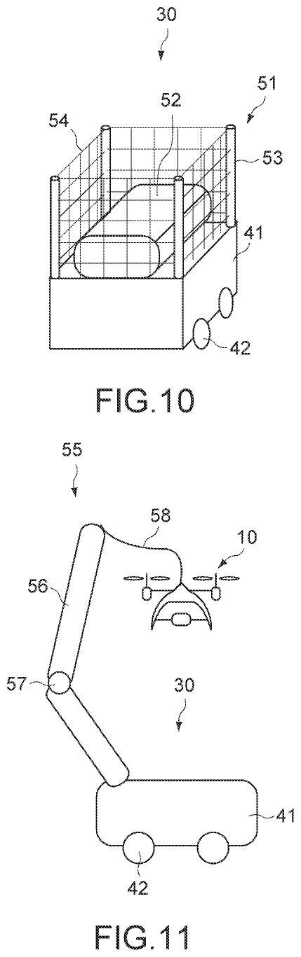

Although the bumper unit 43 uses the net for receiving an impact in the present embodiment, the bumper unit 43 is not limited thereto. Other examples of the bumper unit 43 will be described later in detail with reference to FIGS. 10, 11, and the like.

FIG. 5 is a block diagram showing internal configurations of the autonomous mobile apparatus 30. As shown in FIG. 5, the autonomous mobile apparatus 30 includes the control unit 31, an imaging unit 32, a distance measurement unit 33, a GPS 34, a direction sensor 35, a wheel drive unit 36, a storage unit 37, and a communication unit 38.

The control unit 31 executes various arithmetic operations on the basis of various programs stored in the storage unit 37 and comprehensively controls the respective units of the autonomous mobile apparatus 30.

The imaging unit 32 is capable of imaging the drone 10. In the present embodiment, the imaging unit 32 is configured as an omnidirectional camera and can image a constant 360-degree area in the sky above the autonomous mobile apparatus 30.

The distance measurement unit 33 is capable of measuring a distance (first distance) between the autonomous mobile apparatus body 41 and the drone 10. Any sensor may be used as the distance measurement unit 33 as long as it can measure a distance to the drone 10. Examples of the distance measurement unit 33 can include a time of flight (ToF) camera, a stereo camera, a millimeter-wave radar, an ultrasonic sensor, and a LIDAR.

The GPS 34 generates GPS position information (a self-position of the autonomous mobile apparatus 30 in a global coordinate system) on the basis of signals from the plurality of GPS satellites and outputs the GPS position information to the control unit 31. The direction sensor 35 is for example a geomagnetic sensor. The direction sensor 35 acquires information about a direction (orientation, attitude) of the autonomous mobile apparatus 30 and outputs the information to the control unit 31.

Although the GPS 34 or the direction sensor 35 estimates self-position and attitude of the autonomous mobile apparatus 30 in the example here, other means such as SLAM and LIDAR may estimate the self-position and attitude of the autonomous mobile apparatus 30.

The wheel drive unit 36 is for example a motor and drives the wheels 42 in accordance with the control of the control unit.

The storage unit 37 has various programs necessary for the processing of the control unit 31, a nonvolatile memory for storing various types of data, and a volatile memory used as a working area for the control unit. The communication unit 38 is capable of communication between the drone 10 and the controller 20.

<Operation Description>

[Processing of Autonomous Mobile Apparatus 30]

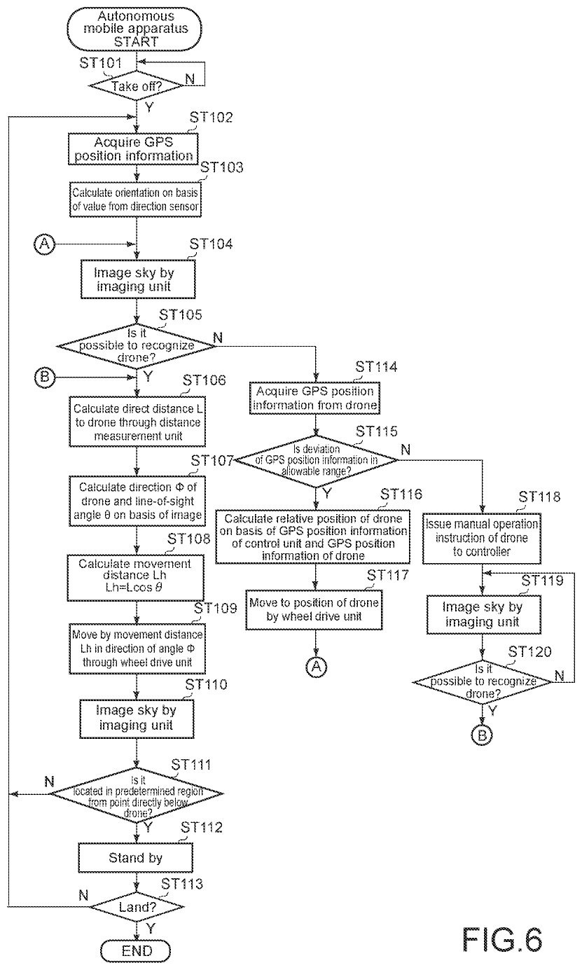

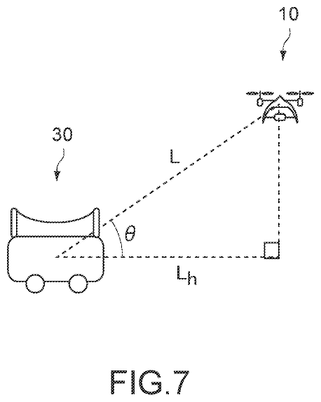

First of all, processing of the control unit 31 of the autonomous mobile apparatus 30 will be described. FIG. 6 is a flowchart showing processing of the control unit 31 of the autonomous mobile apparatus 30. FIG. 7 is a diagram showing a state in determining a distance Lh (second distance) by which the autonomous mobile apparatus 30 should be moved on the basis of a distance L (first distance) between the autonomous mobile apparatus 30 and the drone 10 and a line-of-sight angle θ (first angle) of the drone 10 with respect to the autonomous mobile apparatus 30.

As shown in FIG. 6, first of all, the control unit 31 of the autonomous mobile apparatus 30 determines whether the drone 10 takes off (Step 101). Whether the drone 10 takes off may be determined on the basis of an image from the imaging unit 32 of the autonomous mobile apparatus 30 or may be determined on the basis of information from the drone 10 and the controller 20 (in this case, the drone 10 and the controller 20 send information indicating that the drone 10 takes off to the autonomous mobile apparatus 30 when the drone 10 takes off).

In a case where the drone 10 takes off (YES in Step 101), the control unit 31 of the autonomous mobile apparatus 30 acquires GPS position information of the autonomous mobile apparatus 30 from the GPS 34 (Step 102). Next, the control unit 31 of the autonomous mobile apparatus 30 calculates an orientation of the autonomous mobile apparatus 30 on the basis of direction information of the direction sensor 35. Accordingly, the control unit 31 of the autonomous mobile apparatus 30 estimates self-position and attitude (orientation) in the global coordinate system.

Next, the control unit 31 of the autonomous mobile apparatus 30 images the sky above the autonomous mobile apparatus 30 by the use of the imaging unit 32 (omnidirectional camera) and acquires an image of the sky above the autonomous mobile apparatus 30 from the imaging unit 32 (Step 104). Then, the control unit 31 of the autonomous mobile apparatus 30 determines whether it is possible to recognize the drone 10 in the acquired image (whether the image shows the drone 10) (Step 105).

In a case where it is possible to recognize the drone 10 in the image (YES in Step 105), the control unit 31 of the autonomous mobile apparatus 30 calculates a distance L (first distance) to the drone 10 by the use of the distance measurement unit 33 (Step 106: see FIG. 7).

Next, the control unit 31 of the autonomous mobile apparatus 30 calculates, on the basis of the image of the imaging unit 32, a horizontal angle θ (line-of-sight angle θ: first angle) of the position of the drone 10 with respect to the position of the autonomous mobile apparatus 30 and an angle ϕ (second angle) around a vertical axis of the position of the drone 10 with respect to the position of the autonomous mobile apparatus 30 (Step 107).

Next, the control unit 31 of the autonomous mobile apparatus 30 calculates a movement distance Lh (second distance) of the autonomous mobile apparatus 30 with Lh=L cos θ on the basis of the distance L (first distance) to the drone 10 and the line-of-sight angle θ (first angle) (Step 108: see FIG. 7). Then, the control unit 31 of the autonomous mobile apparatus 30 controls the wheel drive unit 36 to move the autonomous mobile apparatus 30 by the distance Lh in the direction of the angle ϕ (Step 109).

Here, an obstacle or the like disables the autonomous mobile apparatus 30 to move simply straight in some cases. Thus, when moving the autonomous mobile apparatus 30, the control unit 31 of the autonomous mobile apparatus 30 may set a destination at a position (directly below the drone 10) corresponding to the angle ϕ and the distance Lh from the current position, determine a path to the destination from the current position by the use of a path search algorithm, an obstacle avoidance algorithm, or the like, and avoid the obstacle.

Any algorithm may be used as the path search algorithm or the obstacle avoidance algorithm. Examples of those algorithms can include a dynamic window approach (DWA), a model predictive control (MPC), and a rapidly exploring random tree (RRT).

After moving the autonomous mobile apparatus 30, the control unit 31 of the autonomous mobile apparatus 30 images the sky above the autonomous mobile apparatus 30 by the use of the imaging unit 32 (omnidirectional camera) (Step 110). Then, on the basis of the acquired image, the control unit 31 of the autonomous mobile apparatus 30 determines whether the control unit 31 (autonomous mobile apparatus 30) is located at the point (fall position) directly below the drone 10 or in a predetermined region including the point (fall position) directly below the drone 10 (Step 111). That is, in Step 111, the control unit of the automatic mobile apparatus determines whether it is located at a suitable position for receiving the drone 10 by the net portion 45 if the drone 10 falls.

The region size in Step 111 is associated with the size of the net portion 45. The wider the net portion 45 is, the larger the region size is.

In Step 111, in a case where the control unit 31 (autonomous mobile apparatus 30) is not located in the predetermined region with respect to the point directly below the drone 10 (NO in Step 111), the control unit 31 of the autonomous mobile apparatus 30 returns to Step 102.

On the other hand, in a case where the control unit 31 (autonomous mobile apparatus 30) is located in the predetermined region with respect to the point directly below the drone 10 (YES in Step 111), the control unit 31 of the autonomous mobile apparatus 30 stands by at that position (Step 112) and determines whether the drone 10 lands (Step 113).

Whether the drone 10 lands may be determined on the basis of an image of the imaging unit 32 of the autonomous mobile apparatus 30 or may be determined on the basis of information from the drone 10 and the controller 20 (in this case, the drone 10 and the controller 20 send information indicating that the drone 10 takes off to the autonomous mobile apparatus 30 when the drone 10 lands).

In a case where the drone 10 is flying (NO in Step 113), the control unit 31 of the autonomous mobile apparatus 30 returns to Step 102. On the other hand, in a case where the drone 10 lands (YES in Step 113), the control unit 31 of the autonomous mobile apparatus 30 terminates the processing.

It should be noted that during the landing of the drone 10, the control unit 31 of the autonomous mobile apparatus 30 may control the movement of the autonomous mobile apparatus 30 to shift away from the point directly below the drone 10 when the drone 10 descends to a certain height.

In Step 105, in a case where it is not possible to recognize the drone 10 in the image from the imaging unit 32 (omnidirectional camera) (NO in Step 105), the control unit 31 of the autonomous mobile apparatus 30 shifts to Step 114. It should be noted that in a case where it is not possible to recognize the drone 10 in the image, typically, it means that the distance between the autonomous mobile apparatus 30 and the drone 10 is too long and the drone 10 is not located in an angle of view of the imaging unit 32 (omnidirectional camera).

In Step 114, the control unit 31 of the autonomous mobile apparatus 30 sends to the drone 10 a request to acquire GPS position information of the drone 10 (an estimated value of the self-position of the drone 10) and acquires the GPS position information of the drone 10 from the drone 10. At this time, the control unit 31 of the autonomous mobile apparatus 30 acquires from the drone 10 information about a deviation of the GPS position information.

Next, the control unit 31 of the autonomous mobile apparatus 30 determines whether both a deviation of the GPS position information of the control unit 31 (autonomous mobile apparatus 30) and the deviation of the GPS position information of the drone 10 are in a respective allowable range (Step 115).

The deviation of the GPS position information will be described. The GPS receives signals from the plurality of GPS satellites and measures a position of the apparatus (autonomous mobile apparatus 30, drone 10) with the mounted GPS. A position value based on a signal from a GPS satellite and a position value based on a signal from another GPS satellite have a variance. The deviation of the GPS position information is a value of such a variance.

For example, in a case where the autonomous mobile apparatus 30 and the drone 10 are located indoors, the deviation between the autonomous mobile apparatus 30 and the GPS position information of the drone 10 increases, and the accuracy and reliability of the GPS position information of the autonomous mobile apparatus 30 and the drone 10 tend to lower.

That is, in Step 115, whether the GPS position information of the autonomous mobile apparatus 30 (the estimated value of the self-position of the autonomous mobile apparatus 30) and the GPS position information of the drone 10 (the estimated value of the self-position of the drone 10) are reliable with high accuracy is determined.

In a case where both the deviation of the GPS position information of the control unit 31 (autonomous mobile apparatus 30) and the deviation of the GPS position information of the drone 10 are in the respective allowable range (YES in Step 115) (i.e., in a case where both the estimated value of the self-position of the autonomous mobile apparatus 30 and the estimated value of the self-position of the drone 10 are reliable), the control unit 31 of the autonomous mobile apparatus 30 shifts to next Step 116.

In Step 116, the control unit 31 of the autonomous mobile apparatus 30 calculates a relative position of the drone 10 with respect to the control unit 31 (autonomous mobile apparatus 30) on the basis of the GPS position information of the control unit 31 (autonomous mobile apparatus 30) and the GPS position information of the drone 10. Then, the control unit 31 of the autonomous mobile apparatus 30 controls the wheel drive unit 36 to move the autonomous mobile apparatus 30 to the relative position (Step 117). At this time, the path search algorithm, the obstacle avoidance algorithm, or the like may be used as in Step 109.

After moving the autonomous mobile apparatus 30, the control unit 31 of the autonomous mobile apparatus 30 returns to Step 104.

In Step 115, in a case where at least one deviation of the deviation of the GPS position information of the control unit 31 (autonomous mobile apparatus 30) or the deviation of the GPS position information of the drone 10 departs from the allowable range (NO in Step 115) (i.e., in a case where at least one reliability of the estimated value of the self-position of the autonomous mobile apparatus 30 or the estimated value of the self-position of the drone 10 is a predetermined threshold or less), the control unit 31 of the autonomous mobile apparatus 30 shifts to Step 118.

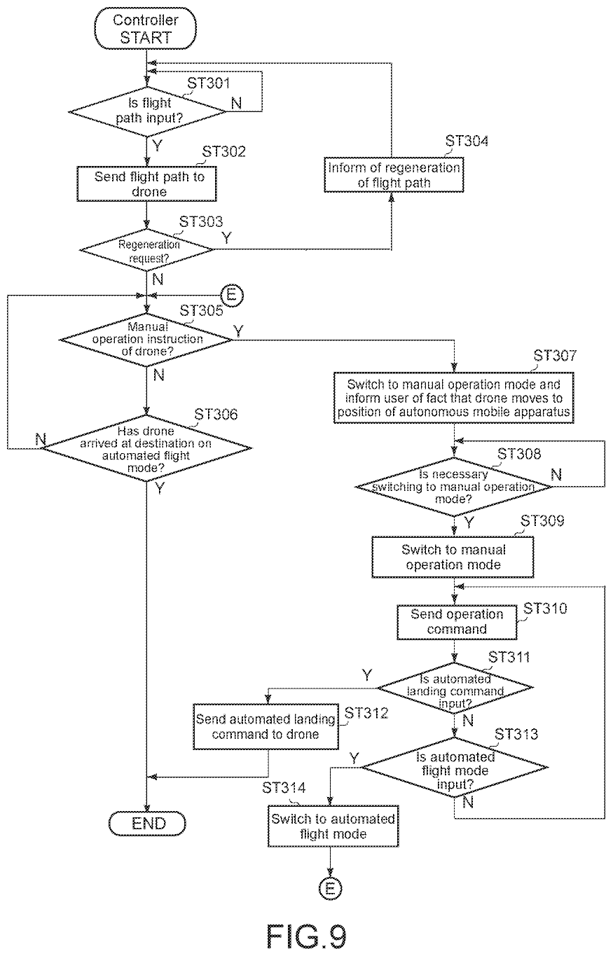

In Step 118, the control unit 31 of the autonomous mobile apparatus 30 issues an instruction to the controller 20 so as to inform the user of a manual operation instruction of the drone 10. As will be described later in detail with reference to FIG. 9, when the user is informed of the manual operation instruction, the user manually operates the drone 10 and moves the drone 10 closer to the position of the autonomous mobile apparatus 30 by checking with eyes.

Although a case where the user manually operates the drone 10 so as to move closer to the autonomous mobile apparatus 30 is described in the example here, the user manually operates the autonomous mobile apparatus 30 so as to move closer to the drone 10 (in this case, for example a controller that operates the autonomous mobile apparatus 30 is added).

After issuing the manual operation instruction of the drone 10 to the controller 20, the control unit 31 of the autonomous mobile apparatus 30 images the sky above the autonomous mobile apparatus 30 by the use of the imaging unit 32 (omnidirectional camera) and acquires an image of the sky above the autonomous mobile apparatus 30 from the imaging unit 32 (Step 119).

Then, the control unit 31 of the autonomous mobile apparatus 30 determines whether it is possible to recognize the drone 10 in the acquired image (whether the image shows the drone 10) (Step 120). In a case where it is not possible to recognize the drone 10 in the image (NO in Step 120), the control unit 31 of the autonomous mobile apparatus 30 returns to Step 119 and images the sky by the use of the imaging unit 32 again.

On the other hand, in a case where it is possible to recognize the drone 10 in the image (YES in Step 120) (i.e., in a case where the user moves the drone 10 closer to the autonomous mobile apparatus 30 by the manual operation and the drone 10 enters the angle of view of the imaging unit 32 of the autonomous mobile apparatus 30), the control unit 31 of the autonomous mobile apparatus 30 shifts to Step 106.

Here, in the present embodiment, as a tracking method of causing the autonomous mobile apparatus 30 to track the flying object, two methods are used: (1) a tracking method based on information from the imaging unit 32 (omnidirectional camera) and the distance measurement unit 33; and (2) a tracking method based on self-positions of the autonomous mobile apparatus 30 and the drone 10.

That is, in the present embodiment, the tracking method (1) is used basically and the tracking method (2) is used as a support if the tracking method (1) does not work effectively. On the other hand, this relationship may be opposite. That is, the tracking method (2) may be used basically and the tracking method (1) may be used as a support if the tracking method (2) does not work effectively.

Alternatively, only one of the tracking method (1) and the tracking method (2) may be used.

[Processing of Drone 10]

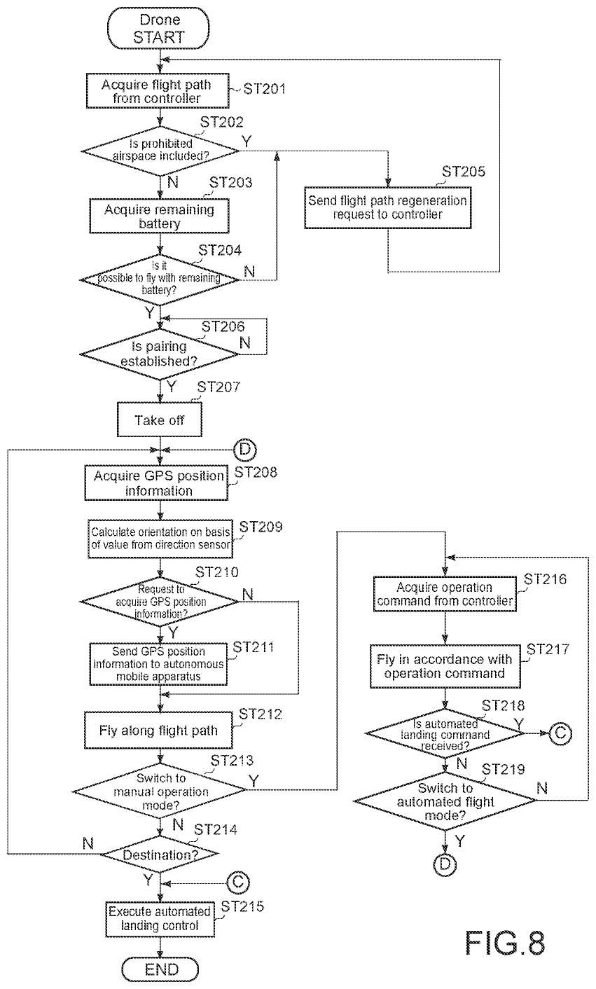

Next, processing at the control unit 11 of the drone 10 will be described. FIG. 8 is a flowchart showing processing at the control unit 11 of the drone 10.

As shown in FIG. 8, first of all, the control unit 11 of the drone 10 acquires information about a flight path from the controller 20 (Step 201). It should be noted that the user generates a flight path in advance by making inputs in the controller 20 before the flight of the drone 10 starts, and the drone 10 flies automatically along this flight path.

When acquiring the information about the flight path, then the control unit 11 of the drone 10 determines whether the flight path includes a prohibited airspace (Step 202). The prohibited airspace is predetermined by the aviation law and the like. The control unit 11 of the drone 10 acquires information about the prohibited airspace from for example a server apparatus over a network.

In a case where the flight path includes the prohibited airspace (YES in Step 202), the control unit 11 of the drone 10 outputs a flight path regeneration request to the controller 20 (Step 205) and returns to Step 201.

In a case where the flight path does not include the prohibited airspace (NO in Step 202), the control unit 11 of the drone 10 acquires information about the current remaining battery of the drone 10 (Step 203). Then, the control unit 11 of the drone 10 compares the length of the flight path with the remaining battery and determines whether it is possible to fly the flight path with the current remaining battery (Step 204).

In a case where it is not possible to fly the flight path with the current remaining battery (NO in Step 204), the control unit 11 of the drone 10 outputs a flight path regeneration request to the controller 20 (Step 205) and returns to Step 201.

It should be noted that in a case where it is not possible to fly the flight path with the current remaining battery but it is possible to fly the flight path after charging the battery, the control unit 11 of the drone 10 may output to the controller 20 an instruction for informing of a request to charge the drone 10 instead of the flight path regeneration request.

In a case where it is possible to fly the flight path with the current remaining battery (YES in Step 204), the control unit 11 of the drone 10 determines whether pairing (wireless link) with the autonomous mobile apparatus 30 is established (Step 206).

In a case where the pairing (wireless link) with the autonomous mobile apparatus 30 is not established (NO in Step 206), the control unit 11 of the drone 10 determines whether pairing (wireless link) with the autonomous mobile apparatus 30 is established again.

In a case where the pairing (wireless link) with the autonomous mobile apparatus 30 is established (YES in Step 206), the control unit 11 of the drone 10 controls the rotary wing driving unit 14 to cause the drone 10 to take off (Step 207).

Next, the control unit 11 of the drone 10 acquires GPS position information of the drone 10 from the GPS 12 (Step 208). Next, the control unit 11 of the drone 10 calculates an orientation of the drone 10 on the basis of information about a direction from the direction sensor 13. Accordingly, the control unit 11 of the drone 10 estimates self-position and attitude (orientation) in the global coordinate system.

Next, the control unit 11 of the drone 10 determines whether a request to acquire the GPS position information of the drone 10 is received from the autonomous mobile apparatus 30 (Step 210) (FIG. 6: see Step 114). In a case where the request to acquire the GPS position information of the drone 10 is received from the autonomous mobile apparatus 30 (YES in Step 210), the control unit 11 of the drone 10 sends the GPS position information of the drone 10 and information about its deviation to the autonomous mobile apparatus 30. Then, the control unit 11 of the drone 10 shifts to next Step 212.

On the other hand, in a case where the request to acquire the GPS position information of the drone 10 is not received from the autonomous mobile apparatus 30 (NO in Step 210), the control unit 11 of the drone 10 shifts to next Step 212 without sending the GPS position information of the drone 10 and information about its deviation to the autonomous mobile apparatus 30.

In Step 212, the control unit 11 of the drone 10 automatically flies along the flight path while checking whether flight is performed correctly along the flight path on the basis of self-position and attitude from the GPS 12 and the direction sensor 13 (Step 212).

Next, the control unit 11 of the drone 10 determines whether the mode in the controller 20 switches from an automated flight mode to a manual operation mode (Step 213). It should be noted that the automated flight mode is a mode on which the drone 10 automatically flies along the flight path and the manual operation mode is a mode on which the drone 10 flies in accordance with the user's manual operation on the controller 20.

In Step 213, in a case where the mode is still the automated flight mode (NO in Step 213), the control unit 11 of the drone 10 determines whether it has arrived at a destination on the flight path (Step 214).

In a case where it has not arrived at the destination on the flight path (NO in Step 214), the control unit 11 of the drone 10 returns to Step 208. On the other hand, in a case where it has arrived at the destination on the flight path (YES in Step 214), the control unit 11 of the drone 10 executes automated landing control and causes the drone 10 to land (Step 215).

In Step 213, in a case where the mode in the controller 20 switches from the automated flight mode to the manual operation mode (YES in Step 213), the control unit 11 of the drone 10 shifts to Step 216.

In Step 216, the control unit 11 of the drone 10 acquires an operation command made by the control sticks 28 of the controller 20 (command for forward, rearward, leftward, and rightward movements, ascending and descending operations, and rolling operations) from the controller 20. Then, the control unit 11 of the drone 10 causes the drone 10 to fly (make forward, rearward, leftward, and rightward movements, ascending and descending operations, and rolling operations) in accordance with the operation command (Step 217).

Next, the control unit 11 of the drone 10 determines whether an automated landing command is received from the controller 20 (Step 218). In a case where the automated landing command is received from the controller 20 (YES in Step 218), the control unit 11 of the drone 10 executes automated landing control and causes the drone 10 to land (Step 215).

On the other hand, in a case where the automated landing command is not received from the controller 20 (NO in Step 218), the control unit 11 of the drone 10 determines whether the mode in the controller 20 switches from the manual operation mode to the automated flight mode (Step 219).

In a case where the mode in the controller 20 is still the manual operation mode (NO in Step 219), the control unit 11 of the drone 10 returns to Step 216. On the other hand, in a case where the mode in the controller 20 switches from the manual operation mode to the automated flight mode (YES in Step 219), the control unit 11 of the drone 10 returns to Step 208.

[Processing of Controller 20]

Next, processing at the control unit 21 of the controller 20 will be described. FIG. 9 is a flowchart showing the processing at the control unit 21 of the controller 20.

As shown in FIG. 9, first of all, the control unit 21 of the controller 20 determines whether the user inputs a flight path for the drone 10 (Step 301). The user inputs the flight path on the basis of map information displayed on the display unit 23 for example.

In a case where the user does not input the flight path (NO in Step 301), the control unit 21 of the controller 20 determines whether the user inputs a flight path again (Step 301).

On the other hand, in a case where the user inputs the flight path (YES in Step 301), the control unit 21 of the controller 20 sends the flight path to the drone 10 (Step 302). Then, the control unit 21 of the controller 20 determines whether the flight path regeneration request is received from the controller 20 within a predetermined time after sending the flight path (Step 303) (FIG. 8: see Step 205).

In a case where the flight path regeneration request is received from the drone 10 (YES in Step 303), the control unit 21 of the controller 20 informs the user of regeneration of the flight path (Step 304) and returns to Step 301. It should be noted that any method such as character or voice presentation may be used for informing the user of regeneration of the flight path.

In a case where the flight path regeneration request is not received from the drone 10 (NO in Step 303), the control unit 21 of the controller 20 determines whether the manual operation instruction of the drone 10 is received from the autonomous mobile apparatus 30 (Step 305) (FIG. 6: see Step 118).

In a case where the manual operation instruction of the drone 10 is not received from the autonomous mobile apparatus 30 (NO in Step 305), the control unit 21 of the controller 20 determines whether the drone 10 has arrived at a destination on the automated flight mode (Step 306).

In a case where the drone 10 has not yet arrived at the destination on the automated flight mode (NO in Step 306), the control unit 21 of the controller 20 returns to Step 305. On the other hand, in a case where the drone 10 has arrived at the destination on the automated flight mode (YES in Step 306), the control unit 21 of the controller 20 terminates the processing.

In Step 305, in a case where the manual operation instruction of the drone 10 is received from the autonomous mobile apparatus 30 (YES in Step 305), the control unit 21 of the controller 20 shifts to Step 307. In Step 307, the control unit 21 of the controller 20 switches the mode from the automated flight mode to the manual operation mode and informs the user of the fact that the drone 10 moves to the position of the autonomous mobile apparatus 30. It should be noted that any method such as character or voice presentation may be used for informing the user of the control unit 31.

Next, the control unit 21 of the controller 20 determines whether the user makes an input for switching the mode from the automated flight mode to the manual operation mode (Step 308). In a case where the user does not make the input for switching to the manual operation mode (NO in Step 308), the control unit 21 of the controller 20 determines whether the user makes the input for switching to the manual operation mode again (Step 308).

On the other hand, in a case where the user makes the input for switching the mode from the automated flight mode to the manual operation mode (YES in Step 308), the control unit 21 of the controller 20 switches the mode from the automated flight mode to the manual operation mode (Step 309).

Next, the control unit 21 of the controller 20 sends an operation command of the drone 10 that is based on the operation of the control sticks 28 (command for forward, rearward, leftward, and rightward movements, ascending and descending operations, and rolling operations) to the drone 10 (Step 310) (FIG. 8: see Step 216). At this time, typically, the user operates the control sticks 28 for operating the drone 10 and moves the drone 10 closer to the autonomous mobile apparatus 30.

Next, the control unit 21 of the controller 20 determines whether the user inputs an automated landing command (Step 311). In a case where the user inputs the automated landing command (YES in Step 311), the control unit 21 of the controller 20 sends the automated landing command to the drone 10 (Step 312) (FIG. 8: see Step 218) and terminates the processing.

On the other hand, in a case where the user does not input the automated landing command (NO in Step 311), the control unit 21 of the controller 20 determines whether the user makes an input for switching the mode from the manual operation mode to the automated flight mode (Step 313).

In a case where the user does not make the input for switching to the automated flight mode (NO in Step 313), the control unit 21 of the controller 20 returns to Step 310.

On the other hand, in a case where the user makes the input for switching to the automated flight mode (YES in Step 313), the control unit 21 of the controller 20 switches the mode from the manual operation mode to the automated flight mode (Step 314), and then returns to Step 305.

It should be noted that typically, the user switches the mode from the manual operation mode to the automated flight mode after moving the drone 10 closer to the autonomous mobile apparatus 30 by a manual operation so that the autonomous mobile apparatus 30 can recognize the drone 10 (FIG. 6: YES in see Step 120).

Although the case where the automated flight mode and the manual operation mode are mixed for the flight of the drone 10 has been described herein, one of the automated flight mode and the manual operation mode may be used.

<Actions, Etc.>

As described above, in the present embodiment, the autonomous mobile apparatus 30 including a bumper unit 43 capable of reducing a fall impact of the drone 10 (flying object) can automatically move to a cross point where a vertically downward straight line of the drone in flight crosses the ground or a surrounding region thereof on the basis of the position of the drone 10. It should be noted that the surrounding region set forth herein includes a circular region with a radius of approximately 1 m to 3 m from the cross point. This prevents a damage due to a fall of the drone 10 to the ground and a damage of a cargo held by the drone 10 for example. Moreover, in the present embodiment, a fall to the ground can be prevented suitably even in a situation where the safety apparatus and the protection function of the drone 10 do not work, such as an error or sudden wind.

Moreover, in the present embodiment, the autonomous mobile apparatus 30 can move alone while tracking the drone 10 and protect the drone 10 even if the drone 10 cannot communicate with the controller 20 due to a communication error with the controller 20.

Here, a first comparative example will be described taking a type of suspending the drone 10 with wires installed throughout a constant region as an example. This type has a problem in that it limits a flight region for the drone 10 to a wire installation region. Moreover, the wire installation has also a problem in that it takes time and cost.

In this regard, in the present embodiment, it is unnecessary to install wires for suspending the drone 10. It can thus reduce time and cost. Also, it does not limit the flight of the drone 10 area to the wire installation area.

Next, a second comparative example will be described taking a type of receiving the drone 10 with a net installed in a constant region as an example. This type also has a problem in that it limits a flight region for the drone 10 to a net installation region as in the first comparative example. Moreover, the net installation also has a problem in that it takes time and cost.

In this regard, in the present embodiment, it is unnecessary to install a net for protecting the drone 10. It can thus reduce time and cost. Also, it does not limit the flight area for the drone 10 to the net installation area.

Next, a case where an airbag is mounted on the drone 10 will be described as a third comparative example. In this case, it is necessary to mount the airbag, chemicals and gas for inflating the airbag, and so on. There is a problem in that they make the drone 10 heavy. Moreover, there is also a problem in that they make the drone 10 bigger.

In this regard, in the present embodiment, it is unnecessary to mount an additional function to the drone itself and it is possible to use generally-used drones commercially available in the current state (though the program may need to be modified slightly for the processing as shown in FIG. 9).

Next, a case where one end of a wire is attached to a distal end of a fishing rod, the other end of the wire is attached to the drone 10, and a person operates the fishing rod for pulling the drone 10 up with the fishing rod and the wire in case of a fall of the drone 10 will be described as a fourth comparative example. In this case, the person has to move while tracking the flight of the drone 10. Moreover, there is a problem in that the person's operation of pulling the drone 10 up in case of a fall of the drone 10 may not be in time.

In this regard, in the present embodiment, the person does not need to move the drone 10 while tracking the drone 10, and it can save the man power. Moreover, it is possible to address a fall of the drone 10 more quickly than the person. It should be noted that the present embodiment can also be said to be a technology for causing the autonomous mobile apparatus 30 to execute the person's operations such as tracking, monitoring, and protecting the drone 10.

Moreover, in the present embodiment, a position of the drone 10 is recognized on the basis of an image of the drone 10 that is acquired by the imaging unit 32, and the autonomous mobile apparatus 30 is moved to a position that is a cross point where a vertically downward straight line of the drone in flight 10 crosses the ground or a surrounding region thereof. Moreover, on the basis of a distance (first distance) to the drone 10 that is measured by the distance measurement unit 33, the autonomous mobile apparatus 30 is moved to the position that is the cross point where the vertically downward straight line of the drone in flight 10 crosses the ground or the surrounding region thereof.

Moreover, in the present embodiment, a line-of-sight angle θ is calculated on the basis of the image of the drone 10. Then, a distance Lh (second distance) by which the autonomous mobile apparatus 30 should be moved is determined on the basis of the line-of-sight angle θ (first angle) and a distance L (first distance) to the drone 10 obtained by the distance measurement unit 33 with Lh=L cos θ (see FIG. 7). This can suitably determine the movement distance Lh of the autonomous mobile apparatus 30, and can suitably move the autonomous mobile apparatus 30 to the position that is the cross point where the vertically downward straight line of the drone in flight 10 crosses the ground or the surrounding region thereof.

Moreover, in the present embodiment, an angle ϕ (second angle) around the vertical axis of the position of the drone 10 with respect to the position of the autonomous mobile apparatus 30 is determined on the basis of the image of the drone 10. Then, the autonomous mobile apparatus 30 is moved to a position corresponding to the angle ϕ and the distance Lh from the autonomous mobile apparatus 30. This can suitably move the autonomous mobile apparatus 30 to the position that is the cross point where the vertically downward straight line of the drone in flight 10 crosses the ground or the surrounding region thereof.

Moreover, using the path search algorithm or the obstacle avoidance algorithm (predetermined algorithm) for the movement of the autonomous mobile apparatus 30 can avoid the obstacle suitably.

Moreover, in the present embodiment, the autonomous mobile apparatus 30 is moved to the position that is the cross point where the vertically downward straight line of the drone in flight 10 crosses the ground or the surrounding region thereof (in a case where it is not possible to recognize the drone 10 with the image) on the basis of the self-position of the autonomous mobile apparatus 30 and the self-position of the drone 10. It should be noted that in the present embodiment, sharing the self-position of the autonomous mobile apparatus 30 and the self-position of the drone 10 can also increase the accuracy of the self-position of the autonomous mobile apparatus 30 and the self-position of the drone 10.

Moreover, in the present embodiment, in a case where the accuracy of the self-position of the autonomous mobile apparatus 30 or the drone 10 is low, the user manually moves the drone 10 to the position of the autonomous mobile apparatus 30 (or moves the autonomous mobile apparatus 30 to the position of the drone 10). This configuration can suitably address the case where the accuracy of the self-position of the autonomous mobile apparatus 30 or the drone 10 is low.

Moreover, the present embodiment employs a receiving system with a net as the bumper unit 43. This can suitably reduce a fall impact of the drone 10.

<Another Example of Bumper Unit>

Next, another example of the bumper unit will be described.

[Cushion-Type]

FIG. 10 is a diagram showing an example in a case where the bumper unit is a cushion-type. As shown in FIG. 10, a bumper unit 51 includes a cushion portion 52, four poles 53, and a net 54.

The cushion portion 52 is provided on the autonomous mobile apparatus body 41 and can protect the falling drone 10.

A relatively soft material such as a sponge, gel, and cotton is used as an example of the material of the cushion portion 52. Alternatively, such a soft material may be used as the cushion portion 52, covered with a covering member such as rubber and cloth depending on needs. Moreover, a gas such as the air may be used as the cushion portion 52, covered with a covering member such as rubber and cloth. Moreover, the cushion portion 52 may be a type of coming out from the autonomous mobile apparatus body 41 in case of a fall of the drone 10 like an airbag.

The four poles 53 are each provided upright at four corners on the upper side of the autonomous mobile apparatus body 41. It should be noted that the number of poles 53 can vary as appropriate. The net 54 is attached to the four poles 53 so as to surround the cushion portion 52. The net 54 is provided for preventing the drone 10 from falling to the outside when the cushion portion 52 receives the falling drone 10.

Also the cushion-type bumper unit 51 as shown in FIG. 10 can suitably reduce a fall impact of the drone 10.

[Arm Suspension Type]

FIG. 11 is a diagram showing an example in a case where the bumper unit is an arm suspension type. As shown in FIG. 11, a bumper unit 55 includes an arm portion 56 and a wire 58. The wire 58 extends from the arm portion 56 and is connected to the drone 10.

The arm portion 56 is attached to the autonomous mobile apparatus 30 so as to extend upward from the autonomous mobile apparatus 30. The arm portion 56 has a proximal end fixed to the autonomous mobile apparatus 30 and a distal end to which the wire 58 is attached. The arm portion 56 has a joint portion 57 and can be bent by driving the joint portion 57. Although a single joint portion 57 is provided in the example shown in FIG. 11, two or more joint portions 57 may be provided.

The wire 58 has one end connected to the distal end of the arm portion 56 and the other end connected to the drone 10. The wire 58 is made of various materials with certain strength or more, such as metal and resin, for example.

With the arm suspension type, detecting a fall of the drone 10 (e.g., communication from the drone 10, an image obtained by the imaging unit 32, or the like) drives the joint portion 57 and drives the arm portion 56 so as to extend upwards. Accordingly, pulling the falling drone 10 up through the wire prevents a fall of the drone 10 to the ground or reduces a fall impact of the drone 10.

Here, the wire 58 may include a power cable for supplying electric power to the drone 10 from the autonomous mobile apparatus 30. Alternatively, the wire 58 may include a communication cable for communication between the autonomous mobile apparatus 30 and the drone 10. Alternatively, the wire 58 may include both the power cable and the communication cable.

In a case where the wire 58 includes a power cable and a communication cable for example, the power cable and the communication cable may be bundled as the wire 58 in order to apply certain strength or more. Alternatively, the power cable and the communication cable wound around a wire made of metal or the like may be generally configured as the wire 58.

In a case where the wire 58 includes the power cable, it enables a long-distance flight of the drone 10. Moreover, omitting the battery for the drone 10 may lighten the drone 10. Moreover, in a case where the wire 58 includes the communication cable, it can reduce communication failures. Moreover, in a case where the drone 10 sends information about a fall of the drone 10 to the autonomous mobile apparatus 30 by communication via the communication cable, the autonomous mobile apparatus 30 may quickly drive the joint portion 57 in accordance with the information so that it can quickly address the fall of the drone 10.

### VARIOUS MODIFIED EXAMPLES

The present technology can also take the following configurations.
(1) An autonomous mobile apparatus, including:
   a mobile unit that moves an autonomous mobile apparatus by driving;
   a bumper unit capable of reducing a fall impact of a flying object; and
   a control unit that controls driving of the mobile unit on the basis of a position of the flying object.
(2) The autonomous mobile apparatus according to (1), further including
   an imaging unit capable of taking an image of the flying object.
(3) The autonomous mobile apparatus according to (2), in which
   the control unit recognizes the position of the flying object and controls driving of the mobile unit on the basis of an image of the flying object acquired by the imaging unit.
(4) The autonomous mobile apparatus according to (2) or (3), further including
   a distance measurement unit that measures a first distance between the autonomous mobile apparatus and the flying object.
(5) The autonomous mobile apparatus according to (4), in which
   the control unit controls driving of the mobile unit on the basis of the first distance.
(6) The autonomous mobile apparatus according to (4) or (5), in which
   the control unit calculates, on the basis of an image of the flying object by the imaging unit, a first angle related to a horizontal direction of the position of the flying object with respect to a position of the autonomous mobile apparatus, and calculates a second distance by which the autonomous mobile apparatus should be moved on the basis of the first angle and the first distance.
(7) The autonomous mobile apparatus according to (6), in which
   assuming that the first angle is denoted by θ, the first distance is denoted by L, and the second distance is denoted by Lh, the control unit calculates the second distance with Lh=L cos θ.
(8) The autonomous mobile apparatus according to (6) or (7), in which
   the control unit calculates, on the basis of an image of the flying object, a second angle around a vertical axis of the position of the flying object with respect to the position of the autonomous mobile apparatus.
(9) The autonomous mobile apparatus according to (8), in which
   the control unit moves the autonomous mobile apparatus to a position corresponding to the second angle and the second distance from the autonomous mobile apparatus.
(10) The autonomous mobile apparatus according to any one of (6) to (9), in which
   the control unit sets a destination at a position corresponding to the second distance from the autonomous mobile apparatus and avoids an obstacle in accordance with a predetermined algorithm with respect to a path to the destination.
(11) The autonomous mobile apparatus according to any one of (1) to (10), in which
   the control unit estimates a self-position, acquires the position of the flying object estimated by the flying object from the flying object, and controls driving of the mobile unit on the basis of the self-position and the position of the flying object.
(12) The autonomous mobile apparatus according to (11), further including
   an imaging unit capable of taking an image of the flying object, in which
   the control unit controls driving of the mobile unit on the basis of the self-position and the position of the flying object when it is not possible to recognize the flying object in the image.
(13) The autonomous mobile apparatus according to any one of (1) to (12), in which
   the control unit moves the autonomous mobile apparatus at a fall position of the flying object in flight or in a predetermined region including the fall position.
(14) The autonomous mobile apparatus according to any one of (1) to (13), in which
   the bumper unit includes a net for protecting the flying object falling.
(15) The autonomous mobile apparatus according to any one of (1) to (13), in which
   the bumper unit includes a cushion portion for protecting the flying object falling.
(16) The autonomous mobile apparatus according to any one of (1) to (13), in which
   the bumper unit includes an arm portion and a wire that extends from the arm portion and is connected to the flying object.
(17) The autonomous mobile apparatus according to (16), in which
   the wire includes a power cable for feeding electric power to the flying object or a communication cable for communication with the flying object.
(18) A flying system, including:
   a flying object; and
   an autonomous mobile apparatus including
      a mobile unit that moves the autonomous mobile apparatus by driving,
      a bumper unit capable of reducing a fall impact of the flying object, and
      a control unit that controls driving of the mobile unit on the basis of a position of the flying object.
(19) A control method, including
   controls driving of a mobile unit on the basis of a position of a flying object in an autonomous mobile apparatus, the autonomous mobile apparatus including the mobile unit that moves the autonomous mobile apparatus by driving and a bumper unit capable of reducing a fall impact of the flying object.
(20) A program that causes an autonomous mobile apparatus to execute
   processing of controlling driving of a mobile unit on the basis of a position of a flying object, the autonomous mobile apparatus including the mobile unit that moves the autonomous mobile apparatus by driving and a bumper unit capable of reducing a fall impact of the flying object.

### REFERENCE SIGNS LIST

10 drone
20 controller
30 autonomous mobile apparatus
43, 51, 55 bumper unit
100 flying system

1. An autonomous mobile apparatus, comprising:
a mobile unit that moves an autonomous mobile apparatus by driving;
a bumper unit capable of reducing a fall impact of a flying object; and
a control unit that controls driving of the mobile unit on a basis of a position of the flying object.

2. The autonomous mobile apparatus according to claim 1, further comprising
an imaging unit capable of taking an image of the flying object.

3. The autonomous mobile apparatus according to claim 2, wherein
the control unit recognizes the position of the flying object and controls driving of the mobile unit on a basis of an image of the flying object acquired by the imaging unit.

4. The autonomous mobile apparatus according to claim 2, further comprising
a distance measurement unit that measures a first distance between the autonomous mobile apparatus and the flying object.

5. The autonomous mobile apparatus according to claim 4, wherein
the control unit controls driving of the mobile unit on a basis of the first distance.

6. The autonomous mobile apparatus according to claim 4, wherein
the control unit calculates, on a basis of an image of the flying object by the imaging unit, a first angle related to a horizontal direction of the position of the flying object with respect to a position of the autonomous mobile apparatus, and calculates a second distance by which the autonomous mobile apparatus should be moved on a basis of the first angle and the first distance.

7. The autonomous mobile apparatus according to claim 6, wherein
assuming that the first angle is denoted by θ, the first distance is denoted by L, and the second distance is denoted by Lh, the control unit calculates the second distance with Lh=L cos θ.

8. The autonomous mobile apparatus according to claim 6, wherein
the control unit calculates, on a basis of an image of the flying object, a second angle around a vertical axis of the position of the flying object with respect to the position of the autonomous mobile apparatus.

9. The autonomous mobile apparatus according to claim 8, wherein
the control unit moves the autonomous mobile apparatus to a position corresponding to the second angle and the second distance from the autonomous mobile apparatus.

10. The autonomous mobile apparatus according to claim 6, wherein
the control unit sets a destination at a position corresponding to the second distance from the autonomous mobile apparatus and avoids an obstacle in accordance with a predetermined algorithm with respect to a path to the destination.

11. The autonomous mobile apparatus according to claim 1, wherein
the control unit estimates a self-position, acquires the position of the flying object estimated by the flying object from the flying object, and controls driving of the mobile unit on a basis of the self-position and the position of the flying object.

12. The autonomous mobile apparatus according to claim 11, further comprising
an imaging unit capable of taking an image of the flying object, wherein
the control unit controls driving of the mobile unit on a basis of the self-position and the position of the flying object when it is not possible to recognize the flying object in the image.

13. The autonomous mobile apparatus according to claim 1, wherein
the control unit moves the autonomous mobile apparatus at a fall position of the flying object in flight or in a predetermined region including the fall position.

14. The autonomous mobile apparatus according to claim 1, wherein
the bumper unit includes a net for protecting the flying object falling.

15. The autonomous mobile apparatus according to claim 1, wherein
the bumper unit includes a cushion portion for protecting the flying object falling.

16. The autonomous mobile apparatus according to claim 1, wherein
the bumper unit includes an arm portion and a wire that extends from the arm portion and is connected to the flying object.

17. The autonomous mobile apparatus according to claim 16, wherein
the wire includes a power cable for feeding electric power to the flying object or a communication cable for communication with the flying object.

18. A flying system, comprising:
a flying object; and
an autonomous mobile apparatus including
a mobile unit that moves the autonomous mobile apparatus by driving,
a bumper unit capable of reducing a fall impact of the flying object, and
a control unit that controls driving of the mobile unit on a basis of a position of the flying object.

19. A control method, comprising
controls driving of a mobile unit on a basis of a position of a flying object in an autonomous mobile apparatus, the autonomous mobile apparatus including the mobile unit that moves the autonomous mobile apparatus by driving and a bumper unit capable of reducing a fall impact of the flying object.

20. A program that causes an autonomous mobile apparatus to execute
processing of controlling driving of a mobile unit on a basis of a position of a flying object, the autonomous mobile apparatus including the mobile unit that moves the autonomous mobile apparatus by driving and a bumper unit capable of reducing a fall impact of the flying object.
